(19) United States
(12) Patent Application Publication
(10) Pub. No.: US 2014/0013444 A1
(43) Pub. Date: Jan. 9, 2014

(54) Authentication using a digital rights management policy

(71) Applicants: Gary Gilchrist, San Francisco, CA (US); Sangameswaran Viswanathan, Sunnyvale, CA (US)

(72) Inventors: Gary Gilchrist, San Francisco, CA (US); Sangameswaran Viswanathan, Sunnyvale, CA (US)

(73) Assignee: Adobe Systems Incorporated

(21) Appl. No.: 11/311,758

(22) Filed: Dec. 19, 2005

(51) Int. Cl. G06F 21/10; G06F 21/31

(52) U.S. Cl. CPC G06F 21/10; G06F 21/31
USPC 726/28

(57) ABSTRACT

Method and apparatus are provided wherein, in one example embodiment, an authentication scheme may be defined as part of a digital rights management policy. Authentication rules are defined for a unit of digital content whose location can be anywhere. Further, the digital rights management system may support many authentication schemes while permitted schemes can be fine tuned for individual policies and therefore for individual units of digital content. According to other example embodiments, one or more preferred authentication schemes can be added to a rights management policy. They can be either requested or required for authentication. In addition, in other example embodiments, the reader application may be informed of specific authentication schemes being demanded for a document. If none of the authentication schemes are available then the user can be informed without attempting to authenticate unsuccessfully.

### RELATED APPLICATIONS

This application is related to U.S. application Ser. No. ______, entitled, “METHOD AND APPARATUS FOR DIGITAL RIGHTS MANAGEMENT POLICIES,” by Gary Gilchrist and Sangameswaran Viswanathan, filed on even date herewith, and assigned to Adobe Systems, Inc.

### TECHNICAL FIELD

The subject matter hereof relates generally to the field of digital rights management, and more particularly to authentication in digital rights management.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005 Adobe Systems, Inc. All Rights Reserved.

### BACKGROUND

Digital rights management (DRM), as its name implies, applies to digital media. Digital media encompasses digital audio, digital video, the World Wide Web, and other technologies that can be used to create, refer to, and distribute digital “content”. Digital media represents a major change from all previous media technologies. Post-production of digital media is cheaper and more flexible than that of analog media, and the end result can be reproduced indefinitely without any loss of quality. Furthermore, digital content can be combined to make new forms of content. The first signs of this are visible in the use of techniques such as sampling and remixing in the music industry.

Digital media have gained in popularity over analog media both because of technical advantages associated with their production, reproduction, and manipulation, and also because they are sometimes of higher perceptual quality than their analog counterparts. Since the advent of personal computers, digital media files have become easy to copy an unlimited number of times without any degradation in the quality of subsequent copies. Many analog media lose quality with each copy generation, and often even during normal use.

The popularity of the Internet and file sharing tools have made the distribution of digital media files simple. The ease with which they can be copied and distributed, while beneficial in many ways, presents both a security risk and a threat to the value of copyrighted material contained in the media. Although technical control measures on the reproduction and use of application software have been common since the 1980s, DRM usually refers to the increasing use of similar measures for artistic and literary works, or copyrightable content in general. Beyond the existing legal restrictions which copyright law imposes on the owner of the physical copy of a work, most DRM schemes can and do enforce additional restrictions at the sole discretion of the media distributor (which may or may not be the same entity as the copyright holder).

DRM vendors and publishers coined the term digital rights management to refer to various types of measures to control access to digital rights, as for example discussed herein, but not limited to those measures discussed herein. DRM may be thought of as a variant of mandatory access control wherein a central policy set by an administrator is enforced by a computer system.

According to one approach to control access to digital media, a DRM system may provide for authorization of document permissions after the user is authenticated and their identity can be trusted. There are a variety of ways that users can authenticate in different environments, for example using passwords, Kerberos tickets, tokens, and biometrics. In some cases, all units of digital content under the control of a particular digital rights management system are subject to the same grade of authentication that must be satisfied before permission assignments in the policy can be authorized.

### BRIEF DESCRIPTION OF THE DRAWING

FIG. 1 illustrates one example embodiment of a system according to the inventive subject matter disclosed herein;

FIG. 2 illustrates one example embodiment of digital content according to the inventive subject matter disclosed herein;

FIG. 3 illustrates an example embodiment of a policy according to the inventive subject matter disclosed herein;

FIG. 4 illustrates one example embodiment of a user interface according to the inventive subject matter disclosed herein;

FIG. 5 illustrates a flow chart of one example embodiment of a method according to the inventive subject matter disclosed herein; and

FIG. 6 illustrates a diagram of one example embodiment of a computing system architecture according to the inventive subject matter disclosed herein.

### DETAILED DESCRIPTION

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the inventive subject matter. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

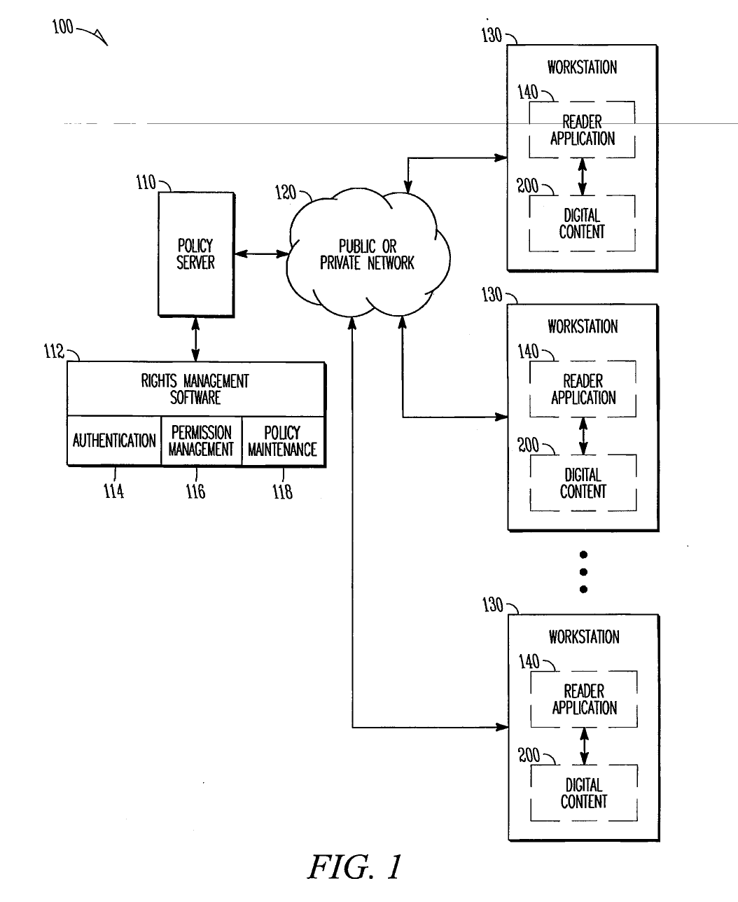

Referring now to FIG. 1 there is illustrated an overview of a first example embodiment of a system 100 that provides an authentication scheme defined as part of a digital rights policy. An authentication scheme may employ any technology accepted by a policy server 110 as a means to authenticate the identity of an end user. As described more fully below, according to one example embodiment of the inventive subject matter, rather than defining authentication rules for fixed network resources, system 100 may use a digital rights policy to define authentication rules for a digital content, for example a digital document or media file, whose location can be anywhere. For example, one or more preferred authentication schemes may be specified as part of a digital content policy as a precondition for its permissions assignments. Such a policy can then be applied to sensitive units of digital content. This allows the document publisher to restrict access to a document based on how its recipients authenticate to the rights management system. For example, for particularly sensitive content, the publisher may require strong authentication that provides a high assurance of a user's identity, for example as may be obtained using two factor authentication. Or, if the content is less sensitive, the authentication may be minimal, such as password protection.

As illustrated in FIG. 1, system 100 includes the policy server 110, one or more networks 120, such as private or public networks, and a plurality of workstation computers 130, such as, but not limited to, personal computers, and reader applications 140 operating on the workstation computers 130. Reader application 140, in one example embodiment, is a client application that opens digital content such as a digital document and enforces permissions, such as, for example but not by way of limitation, the Adobe Acrobat® line of programs, available from Adobe Systems, Inc. Policy server 110 includes rights management software 112 for defining policies, associating policies to a unit of digital content 200, authenticating users, and enforcing policies, for example through interaction with the reader applications 140. The reader application 140 may support. different authentication schemes using, for example but not by way of limitation, biometric devices, Kerboros tickets, tokens, or passwords. Biometric authentication may include fingerprint identification or retinal scan identification. In addition, rights management software 112 includes several functions, including an authentication function 114, a permissions management function 116 and a policy maintenance function 118.

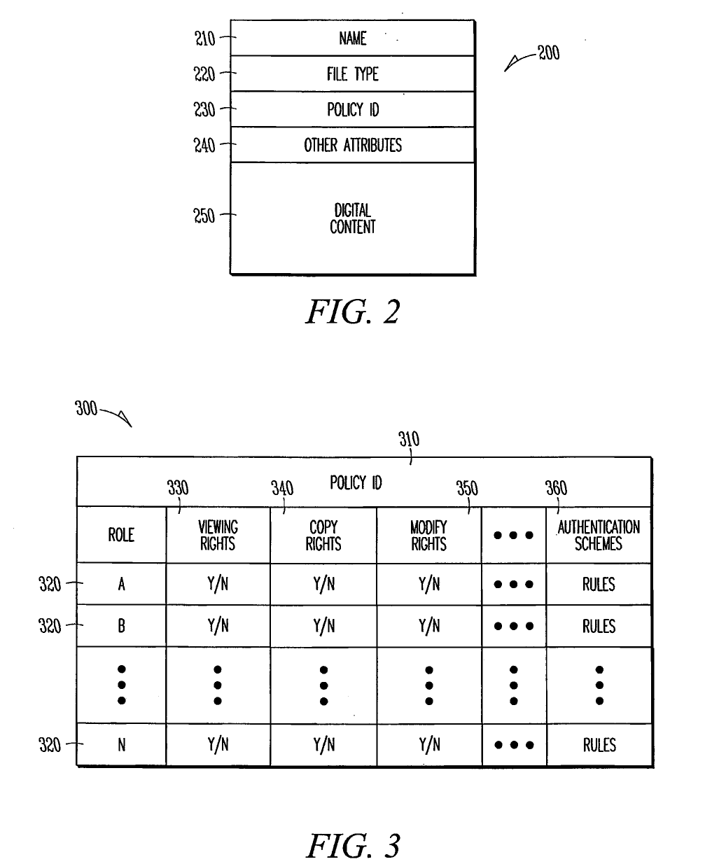

Referring to FIG. 2, there is illustrated one example embodiment of a unit of digital content 200. Unit 200 may, by way of example but not limitation, take the form of an electronic document, for instance in a portable document format (PDF) as is made available by Adobe Systems, Inc., or the form of a digital music file, digital audiovisual work file, or any other type of digital file that contains content that a user may seek to access. Unit 200, for example but not by way of limitation, may include the following components: i) a name 210; ii) indication of file type 220, such as PDF, Word document, Excel spreadsheet or other type of file; iii) the identification 230 of a rights management policy associated with the document, or a copy of the actual policy; iv) other attributes 240; and v) digital content 250 such as a document, illustration, music, audiovisual work, or any other media in digital form.

Referring now to FIG. 3, there is illustrated one example embodiment of a digital rights policy 300. Policy 300 has an identification 310, and specifies, for example, one or more permissions relating to the digital content. For example but not by way of limitation, such permissions may specify, for each of one or more roles 320, the following: i) rights to access and view the content 330; ii) rights to copy the content 340; iii) rights to modify or add to the content 350; and/or iv) authentication rules or schemes 360 for authenticating a user seeking access to the document. A policy 300 may be associated with a unit of digital content 200, for example by tracking an association of the digital content 200 with a policy 300 on the policy server 110, or by replication of the policy 300 in the unit of digital content 200. According to one example embodiment, by adding authentication rules 360 to a policy 300, higher grades of authentication can be enforced for sensitive digital content before users can exercise their permissions on those units of digital content.

According to one example embodiment, accordingly, one or more preferred authentication schemes 360 may be specified as part of a digital content policy as a precondition for its permissions assignments. Such a policy can then be applied to sensitive units of digital content. This document publisher is therefore allowed to restrict access to a document based on how its recipients authenticate to the rights management system administered, for example, by the rights management software 112 on the policy server 110. Rights management software 112 may include, in one example embodiment, authentication functionality 114 that, together with a reader application 140 and optionally additional authentication software or hardware devices, can support many authentication schemes 360. Further, by use of the authentication rules or scheme 360 specified in a policy 300, permitted schemes can be fine tuned for individual units of digital content. According to one example embodiment, policy 300 with authentication schemes 360 as described above may be represented using the portable document rights language (PDRL). supported by Adobe Systems, Inc., for defining document policies on a PDF format document. However, any method or scheme may be used to define a policy for a unit of digital content.

As described more fully below, a policy 300 can be used to authorize access to sensitive units of digital content 200 for intended recipients only. By adding an authentication scheme 360 to the policy definition, the policy 300 is able to offer an additional level of control for sensitive units of digital content 200. Document publishers can, in one example embodiment, force recipients of certain units of digital content 200 to use a preferred authentication technology even if the server supports multiple authentication schemes. Accordingly, in one example embodiment, stronger authentication schemes can be used to authorize permissions on sensitive units of digital content based on using one or more preferred authentication schemes 360. In another example embodiment, when one or more authentication schemes 360 are present (i.e. i.e., associated with or included) in a policy, the server 110 may authorize any permission assignment in that policy 300 for users that authenticate using any of those authentication schemes 360. In another example embodiment, if the policy 300 does not specify any authentication schemes 360, permission assignments in the policy may be authorized for users that satisfy any of the authentication schemes supported by the server 110.

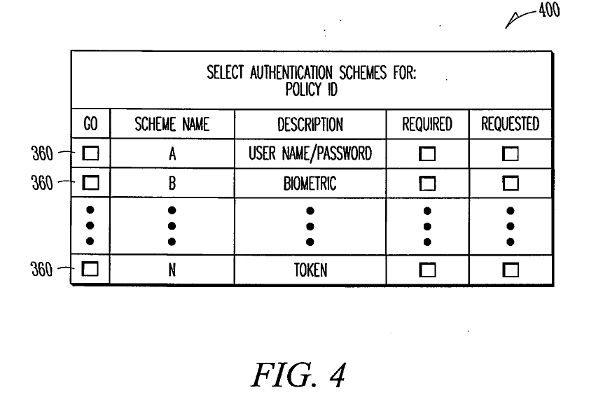

Referring now to FIG. 4, there is illustrated one example embodiment of a user interface 400 supported by the policy server 110. Interface 400 enables the publisher of a document to choose an authentication scheme 360 to use for the unit of digital content being published. For this purpose, as shown in FIG. 4, one or more schemes 360 are displayed in rows (or in any other manner) in a user interface 400 of a policy creating and maintenance functions 118 that may run on the policy server and/or run on a workstation computer 130. User interface 400 provides an interface that allows a user, such as a policy creator, editor, administrator, or other authorized user to select, for example using a pointing device such as a mouse pointer, radio buttons or check-boxes, one or more of the schemes 360 to use to create a specific policy 300 for a particular unit of digital content 200. According to one example embodiment, a selected scheme 360 may be designated as “required” or “requested,” by any desired means, for authentication before permission assignments in the policy can be exercised. A requested authentication scheme is one that the client reader application 140 will be asked to perform if it is possible. A required authentication scheme is one that the client reader application 140 must be able to satisfy when authenticating the user of the content.

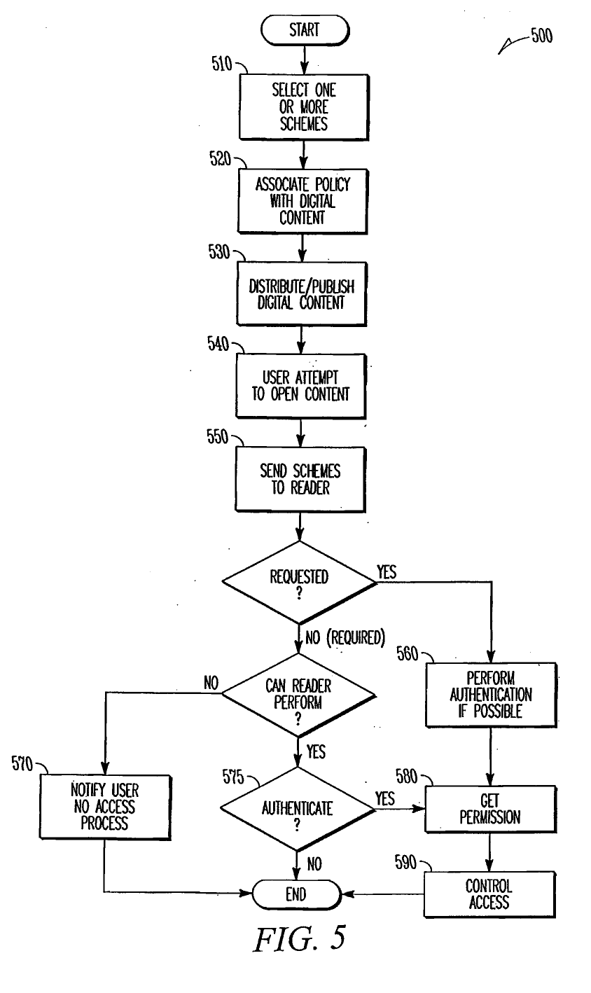

For example but not by way of limitation, to create a specific policy 300, as illustrated in the flow chart 500 of FIG. 5, one or more authentication schemes 360 may be selected 510, for example using a pointing device in a graphical user interface, or alternatively by specifying the name of the authentication scheme. Interface 400 allows authentication schemes 360 in the policy to be marked as “requested” or “required”. The selected scheme or schemes 360, designated as requested or required, may be associated with a policy 300, which may include permissions as noted above. The policy maintenance program 118, for example, may, in one embodiment, associate 520 the policy to a specific unit of digital content 200. After the digital content 200 is distributed 530, a user of the digital content 200 may attempt to open 540 the particular unit of digital content 200. When the user attempts to open the policy protected unit of digital content 200, they must authenticate to policy server 110. If the policy 300 demands one or more authentication schemes 360, then these schemes may, for example, be sent 550 to the client reader application 140 as part of a handshake protocol, or otherwise provided to the reader application 140. If the authentication scheme 360 sent to the reader application 140 is designated as requested, the reader application 140 performs the authentication if possible 560. An authentication scheme may not be possible to perform, for example, if the hardware required for the desired scheme is not available, such as a biometric identification device is not enabled for use by the reader application 140, or the reader application 140 does not have access to a server required for a token-based authentication scheme. If the authentication scheme 360 sent to the reader application 140 is designated as required, the reader application 140 must perform the authentication scheme in order for the user to gain access to the content. If the reader application 140 cannot perform the required authentication scheme, the user is informed 570 that they are unable to gain access to the content 200 using the particular reader application 140 or the particular workstation they are using. If it cannot authenticate 575, according to one example embodiment, the user is informed that the requested authentication cannot be performed without attempting to authenticate unsuccessfully.

If a user is successfully authenticated to the policy server 110, the policy server 110 may inform 580 the reader application 140 of the allowed permissions, which in turn controls access 590 and use of the digital content based on the permissions.

According to one example embodiment, all requested authentication schemes 360 have equal priority and the reader application 140 is free to choose the most appropriate scheme. The reader application 140 may choose a scheme based on any desired scheme, such as starting with the most secure authentication available and ending with the least secure authentication it can support. Similarly, for example, if there is more than one required authentication scheme 360, each may have equal priority and the reader application 140 may be free to choose which to use. In one example embodiment, if an authentication scheme 360 is supported by the reader application 140 then it is used to authenticate the user to policy server 110. [If authentication is successful, the policy server 110 checks to determine if the authentication scheme 360 used matches one of the authentication schemes demanded by the digital content policy 200. If it does not then no permissions are authorized.

According to another example embodiment, the reader application 140 downloads the aggregated permissions and keeps them at least during the session in which the authenticated user is accessing the document. According to another embodiment, the reader application 140 may not download the permissions and instead refer back to the policy server 110 each time it needs to determine if an action sought by the authenticated user is allowed.

According to still another example embodiment, the policy server 110 may also support offline access to policy protected units of digital content 200. In this scenario, the user is not authenticating to the server and therefore authentication schemes in the policy cannot be enforced.

According to yet another example embodiment, a policy of any of the above-described type may be associated with a group, and if a user is a member of that group as determined by the policy server, the user will obtain the permissions of such policy.

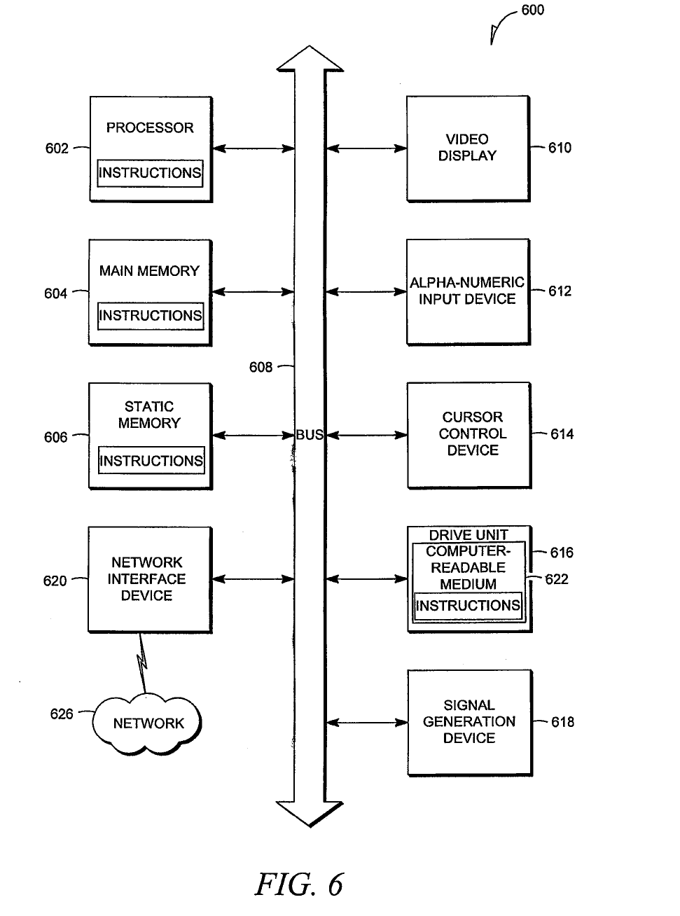

Referring now to FIG. 6, it shows a diagrammatic representation of a machine in the example form of a computer system 600 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device such as a cursor control, 614 (e.g., a mouse), a disk drive unit 616, a signal generation device 618 (e.g., a speaker), and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols, for example the hyper text transfer protocol (HTTP).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals.

According to still another example embodiment, the above described system and method may be used in combination with the method and system for user authentication described in U.S. application Ser. No. ______, entitled, “METHOD AND APPARATUS FOR DIGITAL RIGHTS MANAGEMENT POLICIES”, by Gary Gilchrist and Sangameswaran Viswanathan, filed on even date herewith, and assigned to Adobe Systems, Inc, the entire contents of which are hereby incorporated herein. In particular, the policy creating methods and systems described therein may be used in combination with the systems and methods described herein, for example defining a policy having defined authentication schemes for a unit of digital content using multiple policy templates and/or augmenting a policy template to create a policy associated with a particular unit of digital content.

Thus, as described above, there is provided a method and system wherein, according to certain example embodiments, an authentication scheme may be defined as part of a digital rights management policy. Rather than define authentication rules for fixed network resources, authentication rules are defined for a unit of digital content whose location can be anywhere. Further, the digital rights management system may support many authentication schemes while permitted schemes can be fine tuned for individual policies and therefore for individual units of digital content. According to other example embodiments, one or more preferred authentication schemes can be added to a rights management policy. They can be either requested or required for authentication. Further, the publisher may choose to enforce strong authentication for recipients of sensitive units of digital content or allow recipients to satisfy any form of authentication supported by the digital rights management system. In addition, in other example embodiments, the reader application 140 may be informed of specific authentication schemes being demanded for a document. If none of the authentication schemes are available then the user can be informed without attempting to authenticate unsuccessfully.

In this description, numerous specific details are set forth. However, it is understood that embodiments of the invention may be practiced without these specific details. In other instances, well-known circuits, software, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the inventive subject matter can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Further, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with reference to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

1. (canceled)

2. A system comprising:
a policy server device to support a plurality of authentication schemes used to authenticate a user to the policy server to gain access to a unit of digital content prior to authorizing corresponding permissions indicating permitted use of the unit of digital content once authenticated, the corresponding permissions being indicated in a digital rights management policy for the unit of digital content; and
an interface to receive a selection of an authentication scheme of the plurality of authentication schemes supported by the policy server device to be added to the digital rights management policy containing the corresponding permissions for the unit of digital content,
the policy server device further to
associate the digital rights management policy including the authentication scheme and the corresponding permissions with the unit of digital content,
receive an authentication request with respect to the unit of digital content,
authenticate the user in response to the request using the authentication scheme in the digital rights management policy for the unit of digital content, and
authorize the corresponding permissions in the digital rights management policy in response to the user being authenticated using the authentication scheme in the digital rights management policy.

3. The system of claim 2 further comprising a reader application operable on a computing system to open an electronic file containing the unit of digital content.

4. The system of claim 3 wherein the electronic file is an electronic document file.

5. The system of claim 2 wherein the digital rights management policy comprises more than one authentication scheme.

6.-9. (canceled)

10. A method comprising:
supporting, using a policy server device, a plurality of authentication schemes used to authenticate a user to the policy server device to gain access to a unit of digital content prior to authorizing corresponding permissions indicating permitted use of the unit of digital content once authenticated, the corresponding permissions being indicated in a digital rights management policy for the unit of digital content;
receiving a selection of an authentication scheme of the plurality of authentication schemes supported by the policy server to be added to the digital rights management policy containing the corresponding permissions for the unit of digital content; and
creating the digital rights management policy for the particular unit of digital content, the digital rights management policy comprising the authentication scheme and the corresponding permissions.

11. The method of claim 10 including using a reader application operable on a computing system to open an electronic file containing the unit of digital content.

12. The method of claim 11 wherein the electronic file is an electronic document file.

13. The method of claim 10 wherein the digital rights management policy comprises more than one authentication scheme.

14.-16. (canceled)

17. The method of claim 10 further comprising:
authenticating a user by using the authentication scheme indicated in the digital rights management policy for the unit of content being accessed; and
based on the user being authenticated, allowing the user access to the digital content according to the corresponding permissions in the digital rights management policy.

18.-28. (canceled)

29. The method of claim 10, further comprising receiving a designation of a priority for the authentication scheme, the designation used to determine which authentication scheme of the plurality of authentication schemes is to be used to authenticate the user.

30. The method of claim 29, wherein the priority associated with the authentication scheme is a requested priority, and a reader application that is able to perform the authentication scheme must perform the authentication scheme prior to authorizing the permissions to access the unit of digital content.

31. The method of claim 29, wherein the priority associated with the authentication scheme is a required priority, and wherein a reader application must perform the authentication scheme prior to authorizing the permissions to access the unit of digital content.

32. The method of claim 29, wherein the priority associated with the authentication scheme is equal to a second priority associated with a second authentication scheme of the digital rights management policy, and wherein a reader application may determine which authentication scheme to perform prior to authorizing the permissions to access the unit of digital content.

33. The method of claim 10, wherein the authentication scheme is assigned to a particular role of the digital rights management policy, the digital rights management policy including a plurality of roles.

34. The method of claim 10, wherein the authentication scheme restricts access to the digital content based on how the user authenticates to a rights management system.

35. The system of claim 2, wherein the interface is further to receive a designation of a priority for the authentication scheme, the designation used to determine an authentication scheme of the plurality of authentication schemes to be used to authenticate the user.

36. The system of claim 35, wherein the priority associated with the authentication scheme is a requested priority, and a reader application that is able to perform the authentication scheme must perform the authentication scheme prior to authorizing the permissions to access the unit of digital content.

37. The system of claim 35, wherein the priority associated with the authentication scheme is a required priority, and wherein a reader application is to perform the authentication scheme prior to authorizing the permissions to access the unit of digital content.

38. The system of claim 35, wherein the priority associated with the authentication scheme is equal to a second priority associated with a second authentication scheme of the digital rights management policy, and wherein a reader application is to determine an authentication scheme to perform from the plurality of authentication schemes prior to authorizing the permissions to access the unit of digital content.

39. A non-transitory machine-readable storage medium in communication with at least one processor, the machine-readable storage medium storing instructions which, when executed by the at least one processor, causes a machine to perform operations comprising:
maintaining, using a policy server device, a plurality of authentication schemes used to authenticate a user to the policy server to gain access to a unit of digital content prior to authorizing corresponding permissions indicating permitted use of the unit of digital content once authenticated, the corresponding permissions being indicated in a digital rights management policy for the unit of digital content;
receiving a selection of an authentication scheme of the plurality of authentication schemes supported by the policy server to be added to the digital rights management policy containing the corresponding permissions for the unit of digital content; and
creating the digital rights management policy for the particular unit of digital content, the digital rights management policy comprising the authentication scheme and the corresponding permissions.

40. The system of claim 2, wherein the digital rights management policy for the unit of digital content comprises a plurality of different roles for users, each role having an assigned authentication scheme and a set of corresponding permissions.
